(19) United States
(12) Patent Application Publication
(10) Pub. No.: US 2007/0058375 A1
(43) Pub. Date: Mar. 15, 2007

(54) Light source module and projector using the same

(75) Inventor: Cheng Wang, Hsinchu (TW)

Correspondence Address: BACON & THOMAS, PLLC, 625 SLATERS LANE, FOURTH FLOOR, ALEXANDRIA, VA, 22314, US

(73) Assignee: Young Optics Inc., Hsinchu (TW)

(21) Appl. No.: 11/514,189

(22) Filed: Sep. 1, 2006

(30) Foreign Application Priority Data
Sep. 9, 2005 (TW) 94131232

(51) Int. Cl. F21V 7/00

(52) U.S. Cl. 362/341

(57) ABSTRACT

A light source module includes a light source, an elliptical main-reflector, a paraboloid reflector and a plane reflector. The light source is for generating a light beam. The elliptical main-reflector is for reflecting and converging the light beam. The main-reflector has an axis and a first focal point. The light source is located on the axis and the first focal point coincides with the center of the light source. The parabiloid reflector is connected to the main-reflector for reflecting the light beam to form a parallel light beam. The focal point of the paraboloid reflector coincides with the first focal point. The plane reflector is for reflecting the parallel light beam to the paraboloid reflector. The plane reflector is perpendicular to the axis.

This application claims the benefit of Taiwan application Serial No. 94131232, filed Sep. 9, 2005, the subject matter of which is incorporated herein by reference.

### BACKGROUND OF THE INVENTION

1. Field of the Invention

The invention relates in general to a light source module and a projector using the same, and more particularly to a light source module, which uses an elliptical main-reflector in combination with a paraboloid reflector, and a projector using the same.

2. Description of the Related Art

FIG. 1A is a cross-sectional diagram of a light source module of a conventional projector. Referring to FIG. 1A, the light source module 100 includes an arc lamp 110 and an elliptical reflector 120. The arc lamp 110 is disposed on the axis Z of the elliptical reflector 120, and the first focal point f1 of the elliptical reflector 120 coincides with the light-source center O of the arc lamp 110. A light beam L generated by the arc lamp 110 is reflected by the elliptical reflector 120 and then converged on the rod 130 located at the second focal point f2. However, the design of the elliptical reflector 120 is very sensitive to the arc gap Dg of the arc lamp 110. When the light source module 100 is used for a long time, the arc gap Dg of the arc lamp 100 increases gradually, and the illumination efficiency of the light source module is thus reduced, which in turn reduces the lifetime of the projecting apparatus. Furthermore, owing that the projecting apparatus has a trend to be developed small, when the panel used in the projector apparatus is getting smaller, the illumination efficiency of the light source module 100 will be reduced even more obviously, which in turn lowers down its lifetime greatly. For this reason, the system efficiency of a small-panel projector is far lower than that of a large-panel projector.

FIG. 1B is a cross-sectional diagram of another type of light source module of a conventional projector. Referring to FIG. 1B, the light source module 140 includes an arc lamp 150, an elliptical main-reflector 160 and a spherical minor-reflector 170. The arc lamp 150 is disposed on the axis Z of the elliptical main-reflector 160, and the first focal point f1 of the elliptical main-reflector 160 coincides with the center O1 of the arc lamp 150 and the center O2 of the spherical minor-reflector 170. The left-part light beam L1 generated by the arc lamp 150 is reflected by the main-reflector 160 and then converged on the rod 180 located at the second focal point f2 of the main-reflector 160. The right-part light beam L2 generated by the arc lamp 150 is reflected by the minor-reflector 170 to the main-reflector 160, and then reflected by the main-reflector 160 to the rod 180. Although the illumination efficiency of the light source module 140 is increased by using the combination design of the spherical minor-reflector 170 and the elliptical main-reflector 160, the difficulty in fabricating the spherical minor-reflector 170 and the main-reflector 160 is relatively high, thereby increasing the cost for manufacturing the light source module 140.

### SUMMARY OF THE INVENTION

It is therefore an object of the invention to provide a light source module and a projector using the same. By manufacturing an elliptical main-reflector and a paraboloid reflector into a unity and using a plane reflector to reflect the light beam from the paraboloid reflector back to the main-reflector, the illumination efficiency of the light source module can be increased and thus the cost for manufacturing the light source module can be reduced.

The invention achieves the above-identified object by providing a light source module including a light source, an elliptical main-reflector, a paraboloid reflector and a plane reflector. The light source is for generating a light beam. The elliptical main-reflector is for reflecting and converging the light beam. The main-reflector has an axis and a first focal point. The light source is located on the axis and the first focal point coincides with the center of the light source. The parabiloid reflector is connected to the main-reflector for reflecting the light beam to form a parallel light beam. The focal point of the paraboloid reflector coincides with the first focal point. The plane reflector is for reflecting the parallel light beam to the paraboloid reflector. The plane reflector is perpendicular to the axis.

The invention achieves the above-identified object by providing a projecting apparatus including a light source module and a rod. The light source module includes a light source, an elliptical reflector, a paraboloid reflector and a plane reflector. The light source is for generating a light beam. The elliptical main-reflector is for reflecting and converging the light beam. The main-reflector has an axis and a first focal point, and the light source is located on the axis and the first focal point coincides with the center of the light source. The parabiloid reflector is connected to the main-reflector for reflecting the light beam to form a parallel light beam, and the focal point of the paraboloid reflector coincides with the first focal point. The plane reflector, for reflecting the parallel light beam to the paraboloid reflector, wherein the plane reflector is perpendicular to the axis. The rod is for receiving the light beam reflected from the main-reflector.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a cross-sectional diagram of a light source module of a conventional projector.

FIG. 1B is a cross-sectional diagram of another type of light source module of a conventional projector.

FIG. 2 is a cross-sectional diagram of a light source module of a projector according to a preferred embodiment of the invention.

FIG. 3 is a schematic diagram showing that an elliptical main-reflector and a paraboloid reflector in FIG. 2 form a smooth curved plane at the connection boundary.

FIG. 4 is a schematic diagram of light from the reflector of the light source module in FIG. 2 projecting to the rod and a conventional elliptical reflector.

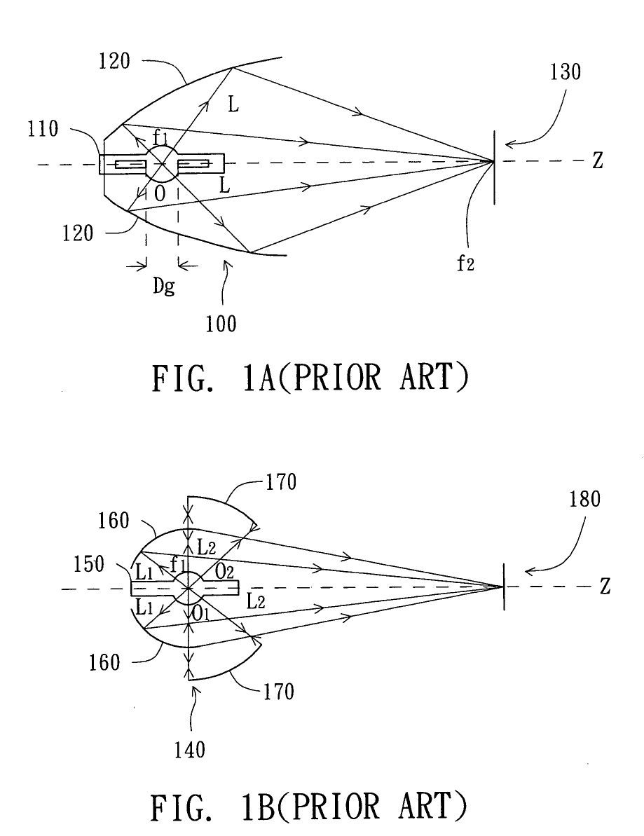

### DETAILED DESCRIPTION OF THE INVENTION

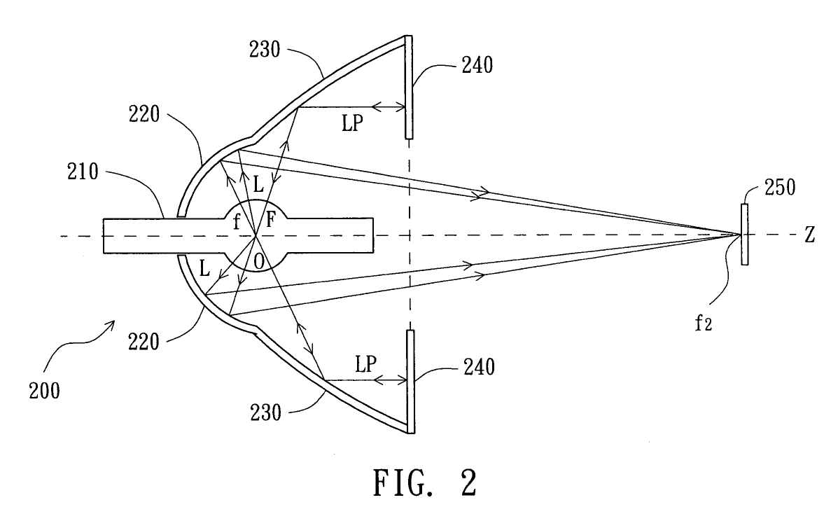

Referring to FIG. 2, a cross-sectional diagram of a light source module of a projector according to a preferred embodiment of the invention is shown. A light source module 200 includes a light source 210, an elliptical main-reflector 220, a paraboloid reflector 230 and a plane reflector 240. The light source 210, such as an arc lamp, is used for generating a light beam L. The light source 210 is disposed on the axis Z of the elliptical main-reflector 220. The first focal point f1 of the main-reflector 220, the center O of the light source 210 and the focal point F of the paraboloid reflector 230 are located at the same point. The light L is reflected by the elliptical main-reflector 220 and then converged on the rod 250 located at the second focal point f2 of the main-reflector 220.

Besides, the paraboloid reflector 230 is connected to the main-reflector 240 for reflecting the light L to form a parallel light beam Lp. The plane reflector 240 is connected to the paraboloid reflector 230 for reflecting the parallel light Lp reflected from the paraboloid reflector 230 back to the paraboilod reflector 230 and the reflected light Lp is reflected again by the main-reflector 220 to enter the rod 250. The plane reflector 240 is perpendicular to the axis Z and the plane reflector 240 is not too long to block the light L reflected from the elliptical main-reflector 220 entering the rod 250.

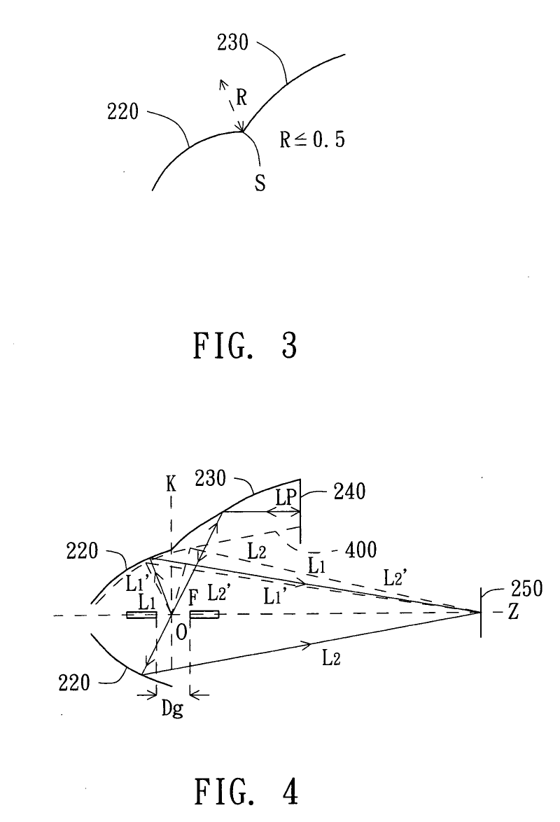

The above-mentioned elliptical main-reflector 220 and paraboloid reflector 230 are formed integrally for instance. In this way, the fabrication difficulty and manufacturing cost for the main-reflector 220 and paraboloid reflector 230 are reduced. In addition, as shown in FIG. 3, the elliptical main-reflector 220 is connected to the paraboloid reflector 230 through a smooth curved plane S. The curvature radius R of the smooth curved plane S is not larger than 0.5 mm such that a lose rate of the lighting efficiency of the light source 210 due to the light L scattered at the smooth curved plane S is controlled under 1%.

Referring to FIG. 4, a schematic diagram of light projecting to the rod 250 from the reflector of the light source module 200 in FIG. 2 and a conventional elliptical reflector. The light beam L1′ is located at the left side of the dotted line K and the light beam L2′ is located at the right side of the dotted line K. The light beam L1′ and the light beam L2′ are reflected by the conventional elliptical reflector 400 to form unequal images at the rod 250. The reflection angle of the light beam L2′ is larger than that of the light beam L1′, so that the image of the light beam L2′ is larger than the image of the light beam L1′. In a conventional elliptical reflector 400, an image projection ratio of the light beam L1′ to the light beam L2′ is about 1:1.5. Therefore, when the arc gap Dg of the light source 210 increases from 1.0 mm to 1.3 mm, the luminance and uniformity of images projected at the rod 250 are greatly reduced.

However, the light source module 200 of the embodiment reflects and converges the left-side light beam L1 onto the rod 250 by the main-reflector 220, in the meanwhile the light source module 200 reflects the right-side light beam L2 to form a parallel light beam Lp by the paraboloid reflector 230. The parallel light beam Lp is reflected by the plane reflector 240 back to the paraboloid reflector 230 and then reflected by the paraboloid reflector 230 to the center O of the light source 210. Due to the feature of parallel light Lp, the light beam in the whole reflection process does not lose. Finally, the light beam reflected from the paraboilod reflector 230 is reflected from elliptical reflector 220 to enter the rod 250. The light beam L2 reflected from the paraboloid reflector 230 to the center O of the light source 210 acts like the light beam L1 directly radiated from the center O and enters the rod 250 after reflected by the elliptical main-reflector 220. Therefore, with the design of the paraboloid reflector 230 and the plane reflector 240, the light source 210 of the light source module 200 has a lower image projection ratio 1:1.2 and the light source module 200 thus has a 15% higher lighting efficiency.

According to the above-mentioned embodiment, the light source module of the invention can improve the illumination efficiency and reduce the fabrication difficulty and manufacturing cost by using the elliptical main-reflector and paraboloid reflector formed integrally in combination with a plane reflector of simply structure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light source module, comprising:
a light source for generating a light beam, the light source having a center;
an elliptical main-reflector for reflecting and converging the light beam, the elliptical main-reflector having an axis and a first focal point, and the light source being located on the axis and the first focal point coinciding with the center of the light source;
a parabiloid reflector connected to the main-reflector for reflecting the light beam to form a parallel light beam, the parabiloid reflector having a focal point coinciding with the first focal point; and
a plane reflector for reflecting the parallel light beam to the paraboloid reflector, the plane reflector being perpendicular to the axis.

2. The light source module according to claim 1, wherein the light source is an arc lamp.

3. The light source module according to claim 1, wherein the elliptical main-reflector and the paraboloid reflector are formed integrally.

4. The light source module according to claim 1, wherein the elliptical main-reflector is connected to the paraboloid reflector through a smooth curved plane.

5. The light source module according to claim 4, wherein a curvature radius of the curved plane is not larger than 0.5 mm.

6. The light source module according to claim 1, wherein the plane reflector is connected to the paraboloid reflector.

7. The light source module according to claim 1, applied in a projector.

8. A projector, comprising:
a light source module, comprising:
a light source for generating a light beam, the light source module having a center;
an elliptical main-reflector for reflecting and converging the light beam, the elliptical main-reflector having an axis and a first focal point, and the light source being located on the axis and the first focal point coinciding with the center of the light source;
a parabiloid reflector connected to the main-reflector for reflecting the light beam to form a parallel light beam, the parabiloid reflector having a focal point coinciding with the first focal point; and
a plane reflector for reflecting the parallel light beam to the
paraboloid reflector, the plane reflector being perpendicular to the axis; and
a rod for receiving the light beam reflected from the main-reflector.

9. The projector according to claim 8, wherein the light source is an arc lamp.

10. The projector according to claim 8, wherein the elliptical main-reflector and the paraboloid reflector are formed integrally.

11. The projector according to claim 8, wherein the elliptical main-reflector is connected to the paraboloid reflector through a smooth curved plane.

12. The projector according to claim 11, wherein a curvature radius of the curved plane is not larger than 0.5 mm.

13. The projector according to claim 8, wherein the plane reflector is connected to the paraboloid reflector.
